(19) United States
(12) Patent Application Publication
(10) Pub. No.: US 2019/0016262 A1
(43) Pub. Date: Jan. 17, 2019

(54) VEHICLE ILLUMINATION ASSEMBLY

(71) Applicant: Nissan North America, Inc., Franklin, TN (US)

(72) Inventor: Julien THIEBAUD, San Diego, CA (US)

(73) Assignee: Nissan North America, Inc.

(21) Appl. No.: 15/650,442

(22) Filed: Jul. 14, 2017

(51) Int. Cl. B60Q 3/70; B60Q 1/50; B60Q 1/24; F21S 8/10

(52) U.S. Cl. CPC B60Q 3/70; B60Q 1/50; F21S 48/21; F21S 48/2231; B60Q 1/24

(57) ABSTRACT

A vehicle illumination assembly is basically provided with a vehicle substrate layer, a fiber optic fabric layer and a light source. The vehicle substrate layer has an inboard side and an outboard side. The fiber optic fabric layer is disposed over the inboard side of the vehicle substrate layer. The light source is arranged to illuminate the fiber optic fabric layer.

### BACKGROUND

### Field of the Invention

This invention generally relates to a vehicle illumination assembly. More specifically, the present invention relates to a vehicle illumination assembly having at least one illumination panel disposed on a vehicle body structure.

### Background Information

Generally, vehicles are equipped with interior lighting or illumination systems such as “dome lights” or “courtesy lights.” Typically, interior lighting structures provide illumination for passengers when entering or exiting the vehicle. Alternatively, an interior lighting structure or illumination system can serve as an indication system for the driver, alerting the driver of external conditions.

### SUMMARY

Generally, the present disclosure is directed to various features of a vehicle illumination assembly. In one feature, a vehicle illumination assembly is provided with illumination panels utilizing fiber optic fabric.

One aspect is to provide a vehicle illumination assembly having a vehicle substrate layer, a fiber optic fabric layer and a light source. The vehicle substrate layer has an inboard side and an outboard side. The fiber optic fabric layer is disposed over the inboard side of the vehicle substrate layer. The light source is arranged to illuminate the fiber optic fabric layer.

Also other objects, features, aspects and advantages of the disclosed vehicle illumination assembly will become apparent to those skilled in the art from the following detailed description, which, taken in conjunction with the annexed drawings, discloses selected embodiments of the vehicle illumination assembly.

### BRIEF DESCRIPTION OF THE DRAWINGS

Referring now to the attached drawings which form a part of this original disclosure:

FIG. 1 is a schematic plan view of a vehicle equipped with a plurality of interior illumination systems in accordance with an illustrated embodiment;

FIG. 2 is a block diagram of a single interior illumination system of the vehicle illustrated in FIG. 1;

FIG. 3 is a schematic plan view of the vehicle illustrated in FIG. 1 equipped with a detection system;

FIG. 4 is a flow chart illustrating a detection cycle of the detection system of the vehicle illustrated in FIGS. 1 and 3;

FIG. 5 is a perspective view of a portion of an interior of the vehicle illustrated in FIGS. 1 and 3;

FIG. 6 is an enlarged plan view of an A-pillar of the vehicle illustrated in FIGS. 1, 3 and 5;

FIG. 7 is a cross-sectional view of an illumination panel for the A-pillar illustrated in FIG. 6;

FIG. 8 is a plan view of a fiber optic fabric layer of the illumination panel illustrated in FIG. 7 having indicium;

FIG. 9 is a plan view of a fiber optic fabric layer of the illumination panel illustrated in FIG. 7 having alternative indicium; and

FIG. 10 is a cross-sectional view of a modified illumination panel for the A-pillar illustrated in FIG. 6.

### DETAILED DESCRIPTION OF EMBODIMENTS

Selected embodiments will now be explained with reference to the drawings. It will be apparent to those skilled in the vehicle field from this disclosure that the following descriptions of the embodiments are provided for illustration only and not for the purpose of limiting the invention as defined by the appended claims and their equivalents.

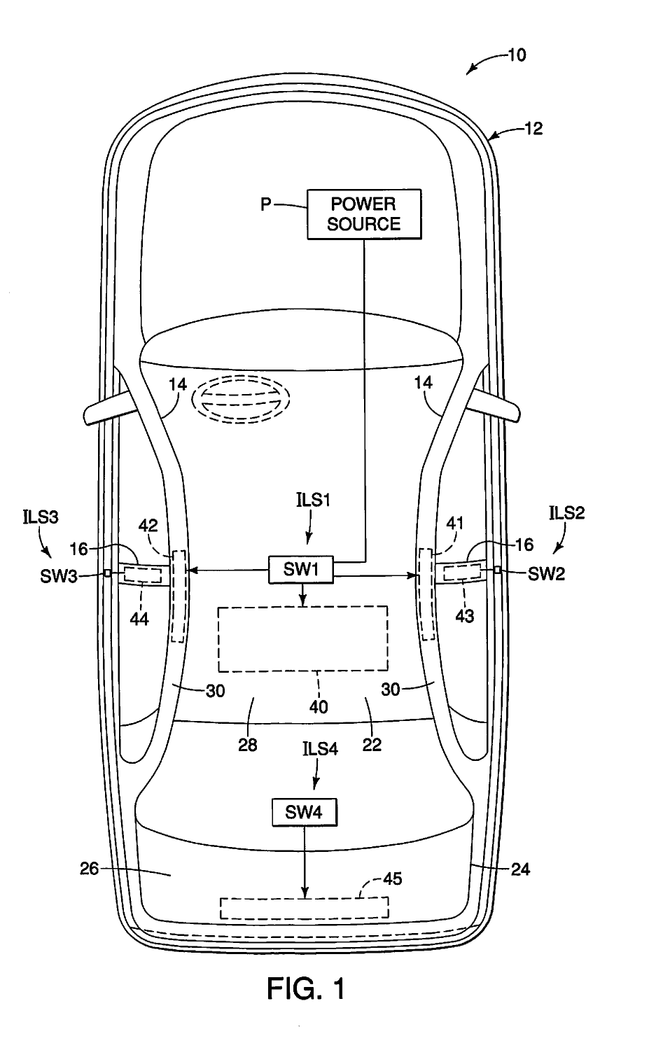

Referring initially to FIG. 1, a vehicle 10 is illustrated that is equipped with a vehicle illumination assembly in accordance with an illustrated embodiment. The vehicle 10 has a vehicle body structure 12 that includes, among other things, a pair of A-pillars 14 and a pair of B-pillars 16. In the illustrated embodiment, the vehicle body structure 12 further includes a pair of C-pillars 18. Since each of the pairs of the A-pillars 14, the B-pillars 16 and the C-pillars 18 are identical except for being mirror images of each other, respectively, only one of the A-pillars 14, one of the B-pillars 16 and one of the C-pillars 18 will be discussed in this disclosure.

The vehicle body structure 12 further includes a rear body panel 20 and a roof structure 22. As shown, a rear hatch 24 is hingedly attached to the rear body panel 20. Thus, the vehicle body structure 12 includes a vehicle cargo area 26. The roof structure includes a roof body 28 and a roof rail portion 30. The A-pillar 14, the B-pillar 16 and the C-pillar 18 are assembled to the roof rail portion 30. In the depicted vehicle body structure 12, there is no clear dividing line between the roof rail portion 30 and the pillars 14, 16 and 18. Rather, the roof rail portion 30 and the pillars 14, 16 and 18 have the appearance of being one single contoured element.

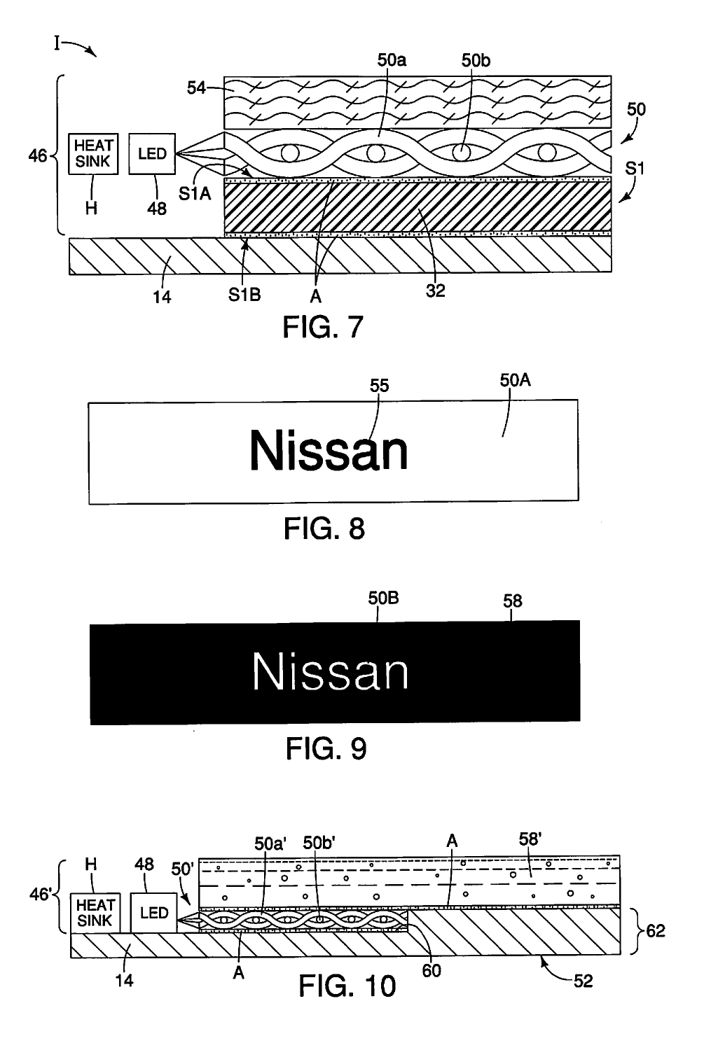

The vehicle 10 can further include a plurality of trim panels fixedly attached to various locations of the vehicle body structure 12 to provide a cosmetic embellishment to the vehicle 10. As seen in FIGS. 6 and 7, a trim panel 32 is disposed on the A-pillar 14. The trim panel 32 can include paint or finish to provide a polished look to a vehicle interior I. For example, the trim panel 32 can be fitted onto the A-pillar 14. Alternatively, the A-pillar 14 can be pre-assembled with the trim panel 32 and then subsequently assembled to the other components of the vehicle body structure 12. Similarly, another trim panel (not shown) can be disposed on the B-pillar 16 and the other components of the vehicle body structure 12. Trim panels and their assembly to the vehicle body structure 12 are well-known in the vehicle field and will not be further discussed in detail herein.

The vehicle 10 further includes at least one interior illumination system and a detection system 36 mounted on the vehicle body structure 12. In particular, as seen in FIG. 1, the vehicle 10 preferably includes a first interior illumination system ILS1, a second interior illumination system ILS2, a third interior illumination system ILS3 and a fourth interior illumination system ILS4. While the vehicle 10 is illustrated as including the first to fourth interior illumination systems ILS1 to ILS4, it will be apparent to those skilled in the art from this disclosure that the vehicle 10 can be equipped with additional or fewer interior illumination system(s) as needed and/or necessary. Also, while the vehicle 10 of the illustrated embodiment is illustrated as a sedan, it will be apparent to those skilled in the art that the interior illumination systems ILS1 to ILS4 can be implemented with a larger or a smaller vehicle. For example, a fifth interior illumination system (not shown) can be implemented with a sports utility vehicle having a D-pillar. In the illustrated embodiment, the interior illumination systems ILS1 to ILS4 are illuminated by illuminating fabric containing optical fibers, as will be further discussed below. In the illustrated embodiment, the interior illumination system(s) and the detection system 36 are two examples of the vehicle illumination assembly, as will be further discussed below.

The vehicle 10 further includes a power source P electrically connected to the detection system 36 and all of the interior illumination systems ILS1 to ILS4. The power source P can be any type of conventional power source P configured to provide power to the vehicle illumination assembly. For example, the power source P can be a car battery. The detection system 36 and the interior illumination systems ILS1 to ILS4 can be connected to the power source P via conventional means and will not be further discussed herein.

The interior illumination systems will now be discussed. The first interior illumination system ILS1 includes a first switch SW1 that activates a first illumination panel 40 disposed on the roof body 28, a second illumination panel 41 and a third illumination panel 42 that are disposed on the roof rail portion 30. The first, second and third illumination panels 40, 41 and 42 are examples of dome or courtesy lights. As such, the first, second and third illumination panels 40, 41 and 42 are preferably illuminated when a driver or passenger enters or exits the vehicle 10. Thus, the first switch SW1 is preferably an automatic switch that is automatically activated when a vehicle door opens and closes. Preferably, the first SW1 can also be manually turned OFF and ON via an operation switch disposed on the vehicle dashboard (not shown).

The second interior illumination system ILS2 includes a fourth illumination panel 43 disposed on the vehicle B-pillar 16 that is activated by a second switch SW2. The fourth illumination panel 43 preferably serves as an additional map light for a rear passenger to read without glare distraction to the driver. Thus, the second switch SW2 is preferably a manual switch disposed on the B-pillar 16 or the rear door so that the passenger can readily activate at will.

The third interior illumination system ILS3 includes a fifth illumination panel 44 that is activated by a third switch SW3. The third interior illumination system ILS3 is identical to the second interior illumination system ILS2 except for its location on the vehicle 10 and therefore will not be further discussed herein.

The fourth interior illumination system ILS4 includes a sixth illumination panel 45 that is activated by a fourth switch SW4. The sixth illumination panel 45 is configured to illuminate the vehicle cargo area 26. Thus, the fourth switch SW4 is preferably an automatic switch that is automatically activated when the rear hatch 24 opens so that the sixth illumination panel 45 lights up the vehicle cargo area 26. Of course, the fourth switch SW4 can be manually turned OFF via an operation switch disposed on the vehicle dashboard (not shown).

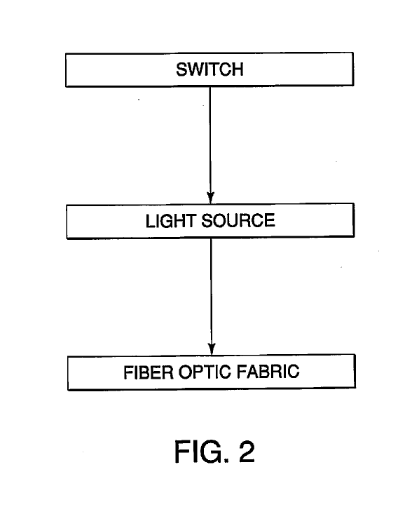

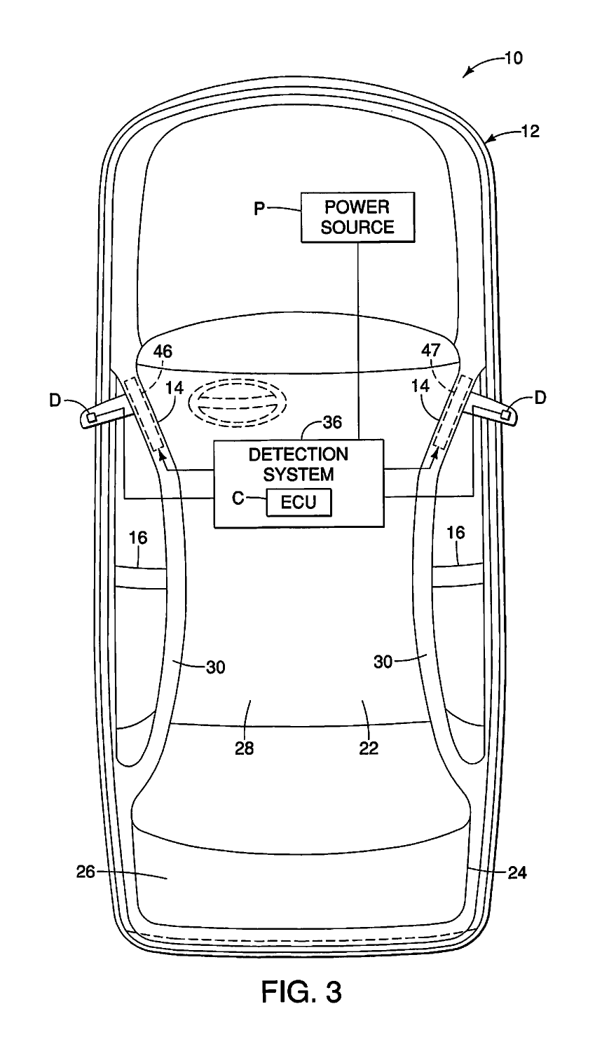

Referring now to FIG. 2, the detection system 36 will now be discussed. In the illustrated embodiment, the detection system 36 includes first and second detectors D. The detectors D are arranged to detect an external object within a detection zone. The detection system 36 also includes a seventh illumination panel 46 and an eighth illumination panel 47. As shown, each of the seventh and eighth illumination panels 46 and 47 are disposed on one of the A-pillars 14. Due to the similarities between the seventh and eighth illumination panels 46 and 47, only the seventh illumination panel 46 will be further discussed herein. The seventh illumination panel 46 includes a light source 48, as will be further discussed below.

The detection system 36 further includes an electronic controller C. The detectors D are configured to generate an activation input upon detecting an external objection within a detection zone. The electronic controller C will then illuminate at least one of the seventh and eighth illumination panels 46 and 47 to indicate the presence of the external object to the driver.

The detectors D will now be discussed. In the illustrated embodiment, the detection system 36 includes two detectors D. It will be apparent to those skilled in the art from this disclosure that the vehicle 10 can be equipped with additional or fewer detectors D mounted on different locations of the vehicle body structure 12 as needed and/or desired. The detectors D are also preferably configured to detect a plurality of external objects within the vicinity of the vehicle 10 upon starting the vehicle 10. The detectors D are in electronic communication with the electronic controller C to transmit an activation input to the electronic controller C upon detection of the external object(s).

The detectors D can also be any type of conventional vehicle sensor as desired. For example, the detectors D can include unidirectional or omnidirectional cameras that take moving or still images of the vehicle surroundings which are transmitted to the electronic controller C for processing. The detectors D can include infrared detectors, ultrasonic detectors, radar detectors, photoelectric detectors, magnetic detectors, acceleration detectors, lasers or any combination thereof. The detectors D can also include object-locating sensing devices including range detectors, such as FM-CW (Frequency Modulated Continuous Wave) radars, pulse and FSK (Frequency Shift Keying) radars, sonar and Lidar (Light Detection and Ranging) devices. Thus, the detectors D can include any type and/or combination of detectors mentioned to enable detection of external objects.

The electronic controller C will now be discussed. The electronic controller C is configured to illuminate at least one of the seventh and eighth illumination panels 46 and 47 upon the detectors D detecting the activation input. The electronic controller C includes a processor and other conventional components such as an input interface circuit, an output interface circuit, and storage devices. The electronic controller C is programmed to determine the presence of the external object upon detection of the external object by the detectors D. In particular, the electronic controller C is programmed to determine whether the external object is within the vicinity of the vehicle 10. In other words, the electronic controller C is programmed to receive the activation input from the detectors D, to process the activation input transmitted by the detectors D, to determine the presence of the external object and to transmit a command signal to the light source 48 to activate the light source 48. Thus, the electronic controller C is programmed to activate the light source 48 upon detecting the activation input from the detectors D.

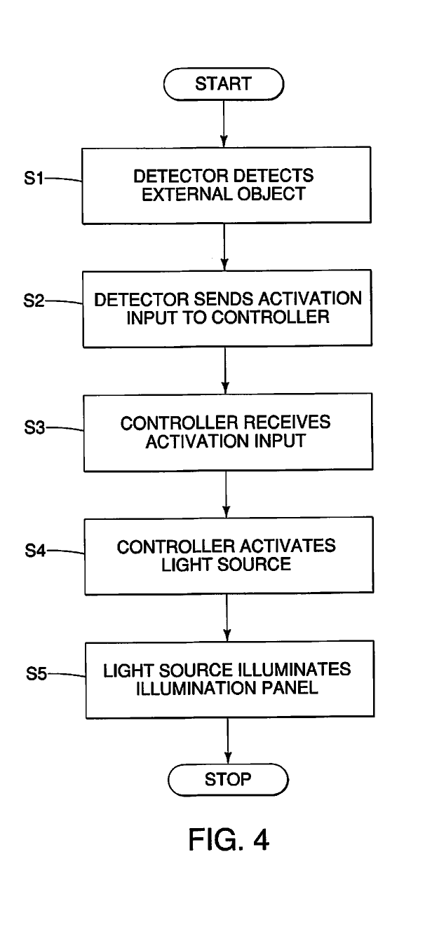

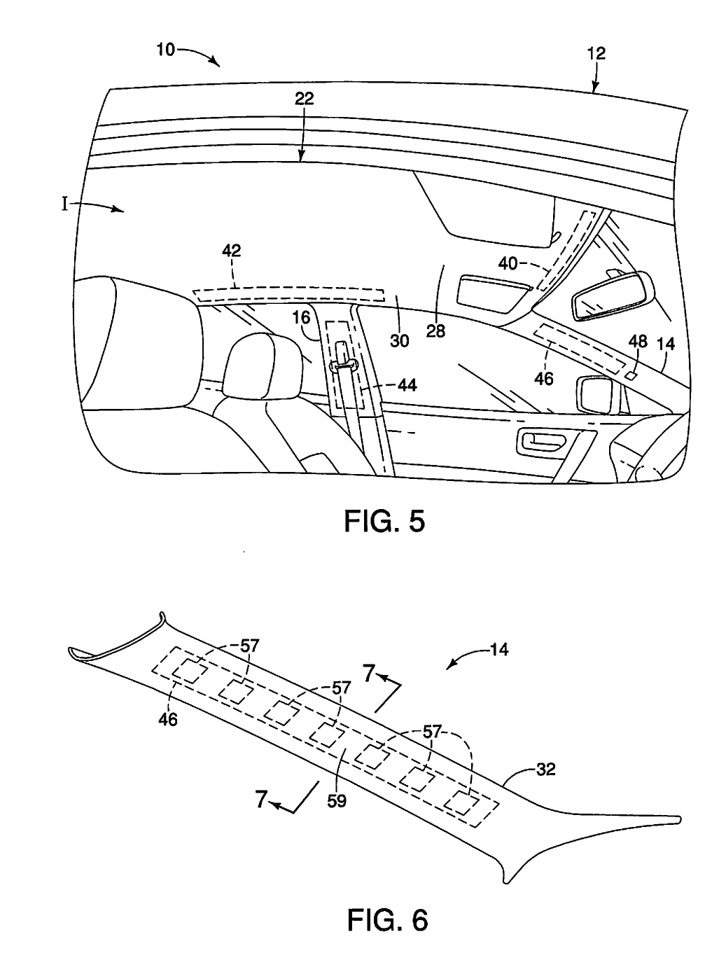

As seen in FIG. 4, the detection system 36 is programmed to perform a detection cycle. In step S1, the detector D detects the external object. In step S2, the detectors D sends an activation input to the electronic controller C. The electronic controller C receives the activation input in step S3. The electronic controller C then activates the light source 48 in step S4. The light source 48 illuminates the seventh illumination panel 46 in step S5.

Preferably, the illumination of the seventh illumination panel 46 conveys a condition of an obstructed viewing area the driver. For example, upon detection of the external object that is a pedestrian by the detectors D, the seventh illumination panel 46 can be illuminated at a particular frequency, intensity or color to reflect the presence of a pedestrian in the vicinity of the vehicle 10. Alternatively, upon detection of an external object that is another vehicle by the detectors D, the seventh illumination panel 46 can be illuminated at a different frequency, intensity or color to reflect the presence of another vehicle in the vicinity of the vehicle 10.

Thus, the electronic controller C can be programmed to activate the light source 48 at different frequencies and/or intensities depending on the type of external objects detected. The different illumination frequency and/or intensity is an example of indicium for the first illumination panel 46.

The seventh illumination panel 46 will now be discussed. In the illustrated embodiment, the illumination panels 40 to 47 are configured similarly except for varying the size and positioning of the illumination panels 40 to 47 on the vehicle body structure 12. Therefore, only the seventh illumination panel 46 that is disposed on the A-pillar 14 will be further discussed in detail herein.

Referring to FIGS. 6 and 7, in the illustrated embodiment, the seventh illumination panel 46 includes a vehicle substrate layer S1 and a fiber optic fabric layer 50. As stated previously, the seventh illumination panel 46 further includes the light source 48, which is disposed adjacent the fiber optic fabric layer 50. The light source 48 is arranged to illuminate the fiber optic fabric layer 50, as will be further discussed below. As the seventh illumination panel 46 is part of the interior illumination system 34 which is part of the vehicle illumination assembly, the vehicle illumination assembly comprises the vehicle substrate layer S1, the fiber optic fabric layer 50 and the light source 48. Additionally, the seventh illumination panel 46 can further include a top layer 54. The seventh illumination panel 46 can further include a spacer layer 55, as will be further discussed below.

As seen in FIG. 6, the seventh illumination panel 46 is illustrated having a plurality of illuminated areas 57 that can be lit up against a non-illuminated area 59. The illuminated areas 57 are illuminated when the fiber optic fabric layer 50 is lit. Thus, as seen in FIG. 6, the fiber optic layer 50 is arranged in a pattern on the seventh illumination panel 46 such that only the illuminated areas 57 are lit. The pattern of the illuminated areas 57 is an indicium on the seventh illumination panel 46. Different types of indicium for the fiber optic fabric layer 50 will be further discussed below.

The vehicle substrate layer S1 of the seventh illumination panel 46 will now be discussed. The vehicle substrate layer S1 has an inboard side S1A and an outboard side S1B. The inboard side S1A faces the vehicle interior I. The fiber optic fabric layer 50 is disposed over the inboard side S1A of the vehicle substrate layer S1.

As illustrated in FIG. 7, the fiber optic fabric layer 50 can be disposed over the trim panel 32 that is assembled on the A-pillar 14. In this instance, the trim panel 32 is an example of the vehicle substrate layer S1. Thus, the vehicle substrate layer S1 is a part of the trim panel 32.

The fiber optic fabric layer 50 of the seventh illumination panel 46 will now be discussed. As stated above, the fiber optic fabric layer 50 is disposed on the inboard side S1A of the vehicle substrate layer S1. The fiber optic fabric layer 50 can be attached to the vehicle substrate layer S1 by an adhesive layer A. Thus, the seventh illumination panel 46 can include the adhesive layer A disposed between the vehicle substrate layer 46 and the fiber optic fabric layer 50.

The fiber optic fabric layer 50 is a textile that can be illuminated by inducing the light source 48 at one end of the fiber optic fabric layer 50. Preferably, the fiber optic fabric layer 50 is a layer of woven flexible, transparent optical fibers. The optical fibers can be made by silica or plastic having a cylindrical transparent core composed of glass or plastic that runs along the fiber's length. The core is surrounded by a medium with a lower index of refraction such as a transparent cladding material. The light emitted by the light source 48 is kept in the core by total internal reflection which causes the fiber to act as a waveguide. The optical fibers are specially processed in order to allow the light to be emitted along the full length of the fibers. The fiber optic fabric layer 50 can include cladded and non-cladded portions 50a and 50b. As shown, only the cladded portions 50a are illuminated by the light source 48.

Alternatively, the optical fibers of the fiber optic fabric layer 50 can be arranged in a planar, parallel array. Specifically, the fiber optic fabric layer 50 can be roughened by hot stamping with emery paper to form a series of interruptions in the cladding of each fiber. The roughened surface of can appear lit when viewed from any angle, while the other side may appear unlit.

As stated above, the seventh illumination panel 46 includes the light source 48. The light source 48 is arranged to illuminate the fiber optic fabric layer 50. Preferably, the light source 48 is connected to the edge of the fiber optic fabric layer 50 to inject light into the fiber optic fabric layer 50. While any conventional light source 48 can be used, preferably, the light source 48 is a light emitting diode (LED). Alternatively, the light source 48 can comprise a light guide (not shown) in the form of a flexible rod or strip and illuminated along the length of the light guide. The light source 48 can be configured to be capable of emitting light at different intensities. Preferably, the light source 48 can also provide illumination of different colors.

Alternatively, the seventh illumination panel 46 can further include a heat sink H operatively disposed adjacent to the light source 48 to dissipate heat generated by the seventh illumination panel 46. For example, the heat sink H can be deformable to fit into a variety of confined spaces on the vehicle substrate layer 46 to dissipate heat generated by the light source 48. Alternatively, the heat sink H can be a flexible heat sink attached to the light source 48 via a heat conducting member and a circuit board. Thus, the heat generated by the light source 48 and the circuit board is conducted to the heat sink H. In this instance, the heat sink H does not need to use a fan to dissipate heat. The flexible heat sink H can be made from braided copper.

As stated, the seventh illumination panel 46 can further include the top layer 54. The top layer 54 is provided over the fiber optic fabric layer 50 to provide a finish and seamless appearance for the seventh illumination panel 46. As shown, the top layer 54 is disposed on the inboard side S1A of the fiber optic fabric layer 50. In the illustrated embodiment, the illumination of the fiber optic fabric layer 50 is visible through the top layer 54. Thus, the top layer 54 is composed of a suitable material that enables the illumination of the fiber optic fabric layer 50 to be visible through the top layer 54. For example, the top layer 54 can be made of a textile such as a felt material including fibers made of wool or from synthetic fibers (e.g., petroleum-based acrylic or acrylonitrile or wood pulp-based rayon). The top layer 54 can be disposed over and attached to the fiber optic fabric layer 50 by an adhesive layer A or other conventional technique.

In the illustrated embodiment, the fiber optic fabric layer 50 can include indicium. In other words, the seventh illumination panel 46 can include indicium. The indicium can include different illumination patterns and colors. Thus, the indicium includes at least one of color, illumination pattern, illumination intensity and illumination frequency. In particular, the fiber optic fabric layer 50 can be configured and/or designed such that different patterns, symbols, colors and varying illumination intensities are visible on the fiber optic fabric layer 50 when the seventh illumination panel 46 is illuminated. As seen in FIGS. 8 and 9, three examples of indicium for fiber optic fabric layers 50A, 50B and 50C are illustrated.

For example, referring to FIG. 8, the fiber optic fabric layer 50A includes a spacer layer 55 that forms the indicium for the fiber optic fabric layer 50A. In the illustrated embodiment, the spacer layer 55 can be a fabric layer of non-optical fibers that is interwoven with the fiber optic fabric layer 50. The spacer layer 55 can be interwoven with the fiber optic fabric layer 50 in a variety of patterns and designs such that only the fiber optic fabric layer 50 is illuminated by the light source 48 during operation. Alternatively, the spacer layer 55 can be a felt layer that is attached to the fiber optic fabric layer 50 via adhesive. In this way, the seventh illumination panel 46 can be selectively illuminated in predetermined areas with the fiber optic fabric layer 50 being illuminated and the spacer layer 55 being non-illuminated when the light source 48 is activated. The different illumination patterns resulting from the spacer layer 55 being interwoven with the fiber optic fabric layer 50 is an example of indicium. Thus, the seventh illumination panel 46 can include the spacer layer 55.

As another alternative, as seen in FIG. 9, the fiber optic fabric layer 50B can include an opaque coating 58 provided in contact with the optical fibers. For example, the opaque coating 58 can take the form of paint. Thus, the indicium of the fiber optic fabric layer 50B includes paint. Optionally, the opaque coating 58 can be formed from a material including, but not limited to, epoxy, latex, polytetrafluoroethylene or a combination thereof. The opaque coating 58 can be provided at different thicknesses on the fiber optic fabric layer 50B such that the light from the fiber optic fabric layer 50 can be emitted at different intensities and/or different shades. A plurality of openings can be provided in the opaque coating 58 (such as via surface roughening). In this way, the fiber optic fabric layer 50B is capable of providing a directional light emission through the opaque coating 58. The seventh illumination panel 46 can further include other types of indicium such as varying illumination frequency, which will be further discussed below.

Referring now to FIG. 10, a modified seventh illumination panel 46′ is illustrated. Here, the fiber optic fabric layer 50′ is illustrated as being disposed over the A-pillar 14 directly. In this instance, the A-pillar 14, which part of the vehicle body structure 12, is an example of a vehicle substrate layer S2. Therefore, in the example of FIG. 10, the vehicle substrate layer S2 is a part of the vehicle body structure 12. Further, as shown, the fiber optic fabric layer 50′ is disposed in a recess 60 of the vehicle substrate layer S2. This example illustrates that the fiber optic fabric layer 50′ can be molded with the vehicle substrate layer S2. Thus, the fiber optic fabric layer 50′ and the vehicle substrate layer S2 can be a molded member 62. The modified seventh illumination panel 46′ further includes an opaque coating layer 58′ that can be selectively applied over the fiber optic fabric layer 50′ to form indicium for the fiber optic fabric layer 50′.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

Also it will be understood that although the terms “first” and “second” may be used herein to describe various components these components should not be limited by these terms. These terms are only used to distinguish one component from another. Thus, for example, a first component discussed above could be termed a second component and vice-a-versa without departing from the teachings of the present invention. The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle illumination assembly comprising:
a vehicle substrate layer having an inboard side and an outboard side;
a fiber optic fabric layer disposed over the inboard side of the vehicle substrate layer; and
a light source arranged to illuminate the fiber optic fabric layer.

2. The vehicle illumination assembly according to claim 1, wherein
the inboard side faces a vehicle interior.

3. The vehicle illumination assembly according to claim 1, wherein
the vehicle substrate layer is a part of a trim panel.

4. The vehicle illumination assembly according to claim 1, wherein
the vehicle substrate layer is a part of a vehicle body structure.

5. The vehicle illumination assembly according to claim 1, further comprising
a top layer disposed on an inboard side of the fiber optic fabric layer, the illumination of the fiber optic fabric layer being visible through the top layer.

6. The vehicle illumination assembly according to claim 1, wherein
the fiber optic fabric layer includes indicium.

7. The vehicle illumination assembly according to claim 6, wherein
the indicium includes paint.

8. The vehicle illumination assembly according to claim 1, further comprising
an adhesive layer disposed between the vehicle substrate layer and the fiber optic fabric layer.

9. The vehicle illumination assembly according to claim 1, wherein
the fiber optic fabric layer is disposed in a recess of the vehicle substrate layer.

10. The vehicle illumination assembly according to claim 1, wherein
the fiber optic fabric layer is molded with the vehicle substrate layer.

11. The vehicle illumination assembly according to claim 3, wherein
the trim panel 32 is disposed on a vehicle A-pillar.

12. The vehicle illumination assembly according to claim 3, wherein
the trim panel 32 is disposed on a vehicle B-pillar.

13. The vehicle illumination assembly according to claim 4, wherein
the vehicle body includes a vehicle trunk portion.

14. A vehicle illumination assembly comprising:
a fiber optic fabric layer disposed over a vehicle substrate layer;
a light source arranged to illuminate the fiber optic fabric layer; and
an electronic controller programmed to activate the light source upon detecting an activation input.

15. The vehicle illumination assembly according to claim 14, further comprising
a detector arranged to detect an external object within a detection zone, the detector being configured to generate the activation input upon detecting the external objection within the detection zone.

16. The vehicle illumination assembly according to claim 15, wherein
the fiber optic fabric layer includes indicium.

17. The vehicle illumination assembly according to claim 16, wherein
the indicium includes at least one of color, illumination pattern, illumination intensity and illumination frequency.
